(19) United States
(12) Patent Application Publication
(10) Pub. No.: US 2013/0286528 A1
(43) Pub. Date: Oct. 31, 2013

(54) ELECTRICAL RELAY CONTROL ARRANGEMENT FOR SWITCHING AN ELECTRICAL RELAY AT ZERO CROSSING OF AN AC MAINS SUPPLY

(71) Applicant: HENDON SEMICONDUCTORS PTY LTD, Hendon (AU)

(72) Inventors: David Murfett, Hendon (AU); Stephen Francis, Hendon (AU)

(21) Appl. No.: 13/866,156

(22) Filed: Apr. 19, 2013

(30) Foreign Application Priority Data
Apr. 27, 2012 (AU) 2012901646

(51) Int. Cl. H01H 47/18

(52) U.S. Cl. CPC H01H 47/18
USPC 361/195

(57) ABSTRACT

An electrical relay contact arrangement for switching an electrical relay ‘on’ or ‘off’ at zero crossings of an AC mains supply, wherein the arrangement rather than immediately sending a control signal from a microprocessor to the input of the electrical relay to close or open the mechanical electrode contacts when switching is required, relies upon a time interval made up two delays, firstly when the microprocessor first recognizes switching is required there is a waiting period until the next zero crossing, and then a further delay which is the time difference between the lag times of the mechanical contact electrodes physically opening or closing and that of the next zero crossing.

### FIELD OF THE INVENTION

This invention relates to an electrical control arrangement of switching an electrical relay on or off and vice versa as required in order to interrupt or connect an electrical supply to a load.

More particularly this invention relates to a unique relay control arrangement and method which is able to accommodate the switching of an electrical relay to an on or off status or vice versa so as to control the AC mains supply to a load wherein such control focuses around the physical electrical contacts of the relay being pulled together or released substantially during zero crossing intervals of the AC mains supply and away from the AC mains supply peaks.

### BACKGROUND OF THE INVENTION

Electrical relays for the most part are electrically operated switches that are both electrical and mechanical in nature in that the electrical relay converts a magnetic flux generated by the application of a low voltage electrical control signal across the relay terminals which is translated into a pulling mechanical force which operates the electrical contacts within a relay.

The relay switching of opening and closing the mechanical contact electrodes are a major factor which determines the electrical relays longevity.

It is well recognised that the opening and closing of the mechanical contact electrodes results in electrical arc forming across these contacts. One of the major determinants as to the degree of burn out and damage to the mechanical contact electrodes will be the magnitude of current flowing at that moment of time when the actual mechanical contact electrodes are pulled closed or at the time that they are physically released.

As is to be expected if the mechanical contacts are being physically pulled closed or released at that moment of time when AC mains supply is at its peak AC current is being switched at its maximum potentially leading to a burn out and/or welding shut of the respective mechanical contact electrodes.

In order to try and overcome the problem to achieve a longer life and higher reliability when switching AC currents whether it be in a resistive, inductive or capacitive load environment, some degree of arc suppression and/or filtering is often introduced across the relay contact. Nonetheless this involves connecting additional componentry which all adds to the cost, usability, available spacing and operability of the electrical relay.

In some instances an electronic controller may be used to try and control the actual physical opening and closing of the electro-mechanical relay at a point of minimum voltage differences between the electrodes. As expected it would be desirable to try to achieve this opening and closing of the mechanical contact electrodes when the voltage at the relay is within the zero crossing interval.

The problem however is that when the electrical relay receives the input to switch between an ‘on’ or ‘off’ state or vice versa there will be a delay period as the magnetic field is energised or de-energised to a sufficient level to begin movement either away or together between the mechanical contact electrodes and there will also be an associated delay due to the amount of time it takes for the mechanical contact electrodes to move in a physical sense from their fully opened to fully closed position.

Accordingly it would be particularly advantageous to be able to control an electrical relay so that it can be switched to an ‘on’ or ‘off’ position or vice versa at a zero crossing interval or at least away from the peaks of an AC mains supply and to do this without having to add additional circuitry to suppress or filter across the relay mechanical contact electrodes.

### SUMMARY OF THE INVENTION

In one form of the invention there is provided an electrical relay contact arrangement for switching an electrical relay ‘on’ or ‘off’ or ‘off’ and ‘on’ at a zero crossing of an AC mains supply, said arrangement including:

a micro-processor in communication with a switching signal, wherein an input from the switching signal to the micro-processor communicates to the microprocessor that an electrical relay is to be switched between ‘on’ and ‘off’ or ‘off’ and ‘on’;

said micro-processor adapted to send an output control signal to the electrical relay so as to switch said electrical relay from ‘on’ to ‘off’ or ‘off’ to ‘on’;

wherein said output control signal is sent from the microprocessor to the electrical rely at a time interval after the switching signal is inputted to the micro-processor wherein said time interval is defined by a first time delay and then a second time delay;

said first time delay characterised in a time between the input of the switching signal to the microprocessor and a next zero crossing of AC mains supply;

a second time delay commencing after the completion of the first time delay characterised in a time between a lag time defined by a time required for mechanical contact electrodes of the electrical rely to be physically pulled from an open to a closed position or physically separated from a closed to an open position and a following zero crossing of AC mains supply;

such that the time interval delays the sending of the output control signal from the microprocessor to the electrical relay so that switching between ‘on’ and ‘off’ or ‘off’ and ‘on’ takes place at zero crossing of AC mains supply.

In a further form of the invention there is provided a relay contact arrangement for switching an electrical relay ‘on’ or ‘off’ or vice versa at zero crossing of an AC mains supply, said arrangement including:

a micro-processor in communication with a switching signal communicating that the electrical relay is to switch between ‘on’ and ‘off’ or ‘off’ and ‘on’ as required;

said micro-processor adapted to provide an output control signal to the electrical relay so as to switch said electrical relay from an ‘on’ to ‘off’ or ‘off’ to ‘on’ as required;

wherein said output control signal is sent at a time interval subsequent to the communication from the switching signal with the micro-processor wherein said time interval is determined by a summation of two time delays;

a first time delay characterised in the time between communication from the switching signal of the requirement of the electrical relay to switch between ‘on’ and ‘off’ or ‘off’ and ‘on’ and the next zero crossing of the AC mains supply;

a second time delay established from the time difference from when the electrical relay receives a command signal to the time the mechanical contact electrodes of the relay are physically pulled closed and/or physically separated wherein this established time difference between the physical opening and/or closing of the mechanical contact electrodes is compared with the amount of time required until the next AC mains supply and zero crossing;

such that the output control signal is delayed so that when the electrical relay needs to switch between an ‘on’ and ‘off’ or an ‘off’ and ‘on’ state the actual physical contact between the mechanical contact electrodes takes place around the zero crossing interval away from AC mains supply peak values.

In preference the calibrated opening or closing times between the mechanical contact electrodes is determined by sending a signal prior to the operation of the relay control arrangement in the field of general use, whereby this initial signal to an input of the electrical relay is then measured as to how long it takes for the mechanical contact electrodes to be physically pulled closed one to the other and wherein the establishment of the opening time is achieved when the initial signal sent to the input of the relay is released and a measurement is taken as to how long the mechanical contact electrodes of the electrical relay take to open.

In preference these measured values of the opening and closing times of the mechanical contact electrodes of the electrical relay are stored in non-volatile memory to which the micro-processor has access.

In preference the non-volatile memory is electrically erasable programmable read-only memory (EEPROM) and is on the same chip as the micro-processor.

In preference the micro-processor is programmed or has inherent logic to recognise the frequency of the AC mains supply such that time intervals between consecutive zero crossing intervals can be calculated by the micro-processor.

In preference the micro-processor has inbuilt logic that allows it to deduce the time delay between the time it takes for an opening or closing of the mechanical contact electrodes of the electrical relay to take place and that of the next zero crossing interval.

In preference the micro-processor is in communication with a circuit that measures zero crossing intervals of the AC mains supply.

Advantageously before the relay control arrangement which will switch the electrical relay to the required ‘on’ and ‘off’ state is used as its function to control electric power to a load, in this invention a signal is first applied to the relay input so it is possible to measure how long it actually takes the relay to physically close and when this signal is then released from the relay input a measurement is made available as to how long it takes the relay to open.

With this information at hand it then becomes possible to measure the time lag from when an actual control signal is sent to the relay to switch it between an ‘on’ and ‘off’ state or alternatively an ‘off’ to an ‘on’ state to when the actual mechanical contacts are pulled closed or released open.

This information is then combined with the frequency of the AC mains supply.

For example an AC mains supply at 50 Hz would have a zero crossing at 10 ms apart. If a specific relay has a closing lag of 7.3 ms, that is the time interval between applying the control signal to the relay to the time that the actual contacts are pulled closed together, it is then possible to program into the micro-processor's non-volatile memory (or at least the memory with which the micro-processor is in communication) a delay of 2.7 ms from a first zero-crossing event which would see the relay close at a next zero crossing event.

Therefore when a control signal is sent to the relay in order to close the mechanical contact electrodes one with the other there will be firstly a delayed break until the next zero crossing interval, a subsequent delay has been programmed into the memory based on that specific relay that is part of the relay control arrangement which will be the lag time between the opening and closing of the mechanical contact electrodes and the time difference to the next zero crossing.

Such that the actual signal which will bring about the physical movement of the mechanical contact electrodes only takes place after these two delays, and with consideration of these two delays and then the actual elapsing of the lag time which it takes to actually open or close the mechanical contact electrodes, this brings about a scenario that at point of when the mechanical contact electrodes are pulled closed or released this will then happen at zero crossing intervals.

Advantageously there has been no additional components that have to be used in combination with the relay so as to suppress or filter potential peak currents.

In order now to describe the invention in greater detail preferred embodiments will be presented with the assistance of the following illustrations.

### BRIEF DESCRIPTION OF THE DRAWINGS

While the preferred embodiment shows voltage zero crossings the invention should not be considered as so restrictive and for those highly inductive or capacitive loads switching could be just as easily synchronized to a zero crossing for current and so forth as required.

In those embodiments where there are combinations of both inductive and capacitive influences the micro-processor would be adapted to work with circuitry that measures the appropriate zero crossings.

FIG. 1 is a graphical representation of the AC mains supply wave form and the time intervals which lead to the physical opening or closing of the mechanical contact electrodes of the electrical relay outside those peak periods.

FIG. 2 is a similar graphical representation as that shown in FIG. 1 however in this embodiment the actual lag time for the relay to physically close or open upon receipt of the input control system to switch between an ‘on’ to ‘off’ or an ‘off’ to ‘on’ state is longer than a measured zero crossing interval at a 50 Hz frequency AC mains supply.

### DETAILED DESCRIPTION OF THE INVENTION

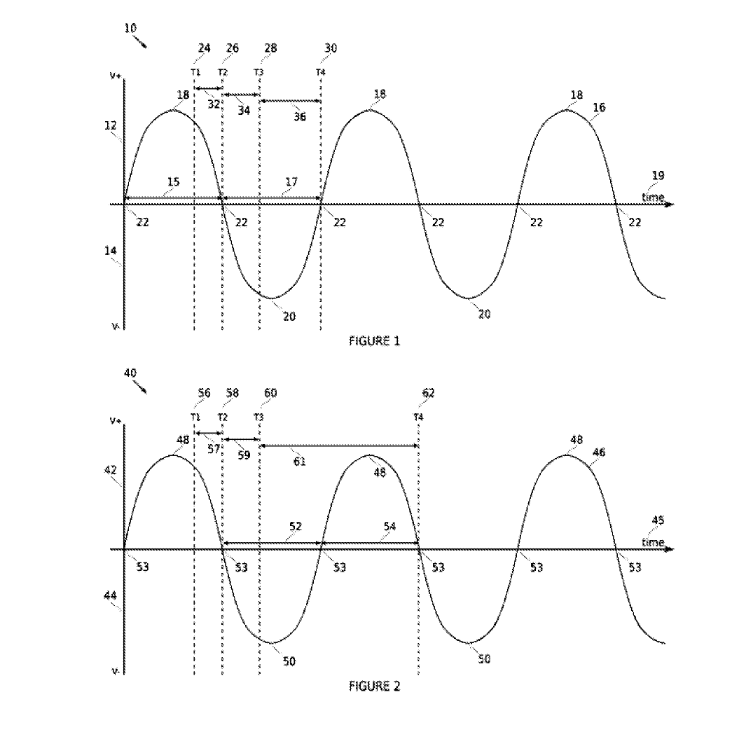

Referring to FIG. 1 wherein the embodiment shown generally as (10) includes voltage, recognizes a positive voltage (12) and negative voltage (14) with time shown generally as (19).

The AC mains supply wave form (16) includes a series of positive main peaks shown as (18) along with negative main peaks (20) and the intermittent zero crossing intervals shown generally as (22).

For an AC mains supply at 50 Hz the zero crossings are 10 ms apart shown generally as (15) and (17).

T1 (24), T2 (26), T3 (28) and T4 (30) represent various events which ultimately lead to the physical closing or opening of the mechanical contacts in the electrical relay which is under the influence of the control arrangement for this invention at a zero crossing interval.

T1 represented as (24) is when the micro-processor comes into communication with a switching signal which is communicating to the micro-processor that there is a requirement to switch the electrical relay between an ‘on’ to ‘off’ or ‘off’ to ‘on’ position by either opening or closing the mechanical contact electrodes of the electrical relay as required.

Rather than immediately sending a control signal to the input of the electrical relay to close the contact, the micro-processor takes into consideration various information and data that it has access to.

Before sending the switching signal immediately off to the input of the electrical relay, there is the interval of time (32) between T1 and T2 wherein the micro-processor first recognizes action to be taken and the requirement to wait until the next zero crossing, it then waits for a further delay which is the time difference between the lag time of the mechanical contact electrodes physically opening or closing shown as (36) and that of the next zero crossing.

For example in the embodiment shown in FIG. 1 it was recognised that for an AC mains supply with a frequency at 50 there would be zero crossings at each 10 ms intervals.

In the example shown in FIG. 1 purely as a way of illustrating this invention, a signal was sent to the input of the electrical relay prior to the electrical relay functioning as it should in switching the AC current as required.

This signal that was applied to the relay input was measured and determined that the time it took for the mechanical contact electrodes to be pulled closed took a period of 7.3 ms. This meant that there was a difference of 2.7 ms until the next zero crossing if the initial measure was taken at the previous zero crossing.

So accordingly in the operation of the electrical relay functioning as it would to switch AC currents as required the micro-processor must first wait for the period shown between T2 (26) and T3 (28) for the period (34) of 2.7 ms before the micro-processor sends the control signal to the input of the electrical relay.

Point T3 through to point T4 then represents that lag time as to when the control signal is sent to the input of the relay and the actual time it takes to physically close the mechanical contact electrodes.

As is to be expected the same procedure would then follow for the opening of the contacts.

There would first of all be a recognition that a control signal has been received by the micro-processor that requires the opening of the mechanical contact electrodes. A period of time would then elapse until the next zero crossing and then the time delay so that when the actual control signal is sent to the input of the electrical relay the lag time in which to open the mechanical contact electrodes will be completed at the opportune time when the main supply is at the zero crossing interval.

But once again by being able to originally supply a signal to the relay input and measure how long it takes for the relay to close and then release the signal and measure how long it takes for the relay to open, and placing this information for the use by the micro-processor has resulted in a simple timing mechanism rather than alternative circuit design in being able to achieve longevity of use of the relay by minimizing the consequences of electrical arcing particularly in the case when AC current is being switched when the voltage would have been away from these zero crossing intervals.

While the example in FIG. 1 has shown the actual contacting of the mechanical contact electrodes precisely at the zero crossing interval, and the discussion above also recognizes that the opening of the mechanical contact electrodes also occurring precisely at the zero crossing interval, the scope of the invention should not be read so narrowly as the main purpose is to make sure that switching is not taking place close or near the main peaks of the AC mains supply.

In FIG. 2 the scenario is illustrated where the actual lag time of first sending the control input into the relay and the actual physical contact between the mechanical contact electrodes being closed is longer than one zero crossing interval.

In these kinds of embodiments the difference still in a sense remains the same in that the time difference between that time lag which was measured by applying a signal to the electrical relay before using the electrical relay in its normal function and then seeing how much further time is required before the next zero crossing interval is reached.

In the embodiment shown as (40) positive voltages (42) and negative voltages (44) are shown along the vertical and along the horizontal the elapsing of time (45).

The AC mains supply wave form (46) includes a series of positive peaks (48) and negative voltage peaks (50).

These peaks are separated by zero crossing intervals (53) and as the embodiment shown in FIG. 2 also has the AC mains supply at 50 Hz the time between consecutive zero crossing intervals (52) remains at 10 ms. It will be appreciated that other frequencies can be employed.

Again the purpose of FIG. 2, like FIG. 1, is to just demonstrate the invention pictorially for a greater understanding, the actual values and times involved are not part of the inventive concept. What is essential to the invention is the calibrating of the time it takes to either physically open or close the mechanical contact electrodes and then recognizing that timing and determining the differences in time up to the next zero crossing interval so that this time difference can then be incorporated into non-volatile memory for the micro-processor to utilise as it controls this same electrical relay.

T1 shown as (56) is the time that the micro-processor receives communication from a switching signal that it is time for the relay to switch. However before a control signal is sent to the relay to switch it from ‘on’ to ‘off’ or ‘off’ to ‘on’, there is an inbuilt delay (57) until the next zero crossing interval occurs shown as T2 (58) wherein then the time difference between the closing lag time (61) and that of the next zero crossing establishes the delay period (59) which is placed into the non-volatile memory which the micro-processor will access.

Hence when switching is to occur the next zero crossing interval is waited for, as shown by (57), the delay (59) is then introduced at T2 which a micro-processor has obtained that delay time from the non-volatile memory which is programmed there into and thereafter a control signal is sent to the input of the relay so that switching can commence and by the time the physical contact between the mechanical contact electrodes are made, the lag time (61) in the closed position which occurs at T4 (62) this is in the zero crossing interval (53) of the AC mains supply wave form (46).

Consequently current magnitude is at a minimum and the consequences of electrical arcing are substantially ameliorated or removed thereby providing longevity to the electrical relay.

1. An electrical relay contact arrangement for switching an electrical relay ‘on’ or ‘off’ or ‘off’ and ‘on’ at a zero crossing of an AC mains supply, said arrangement including:
a micro-processor in communication with a switching signal, wherein an input of the switching signal to the micro-processor communicates to the microprocessor that an electrical relay is to be switched between ‘on’ and ‘off’ or ‘off’ and ‘on’;
said micro-processor adapted to send an output control signal to the electrical relay so as to switch said electrical relay from ‘on’ to ‘off’ or ‘off’ to ‘on’;
wherein said output control signal is sent from the microprocessor to the electrical rely at a time interval after the switching signal is inputted to the micro-processor wherein said time interval is defined by a first time delay and then a second time delay;
said first time delay characterised in a time between the input of the switching signal to the microprocessor and a next zero crossing of AC mains supply;
a second time delay commencing after the completion of said first time delay characterised in a time between a first lag time defined by a time required for mechanical contact electrodes of the electrical rely to be physically pulled from an open to a closed position or a second lag time defined by a time required to physically separate the mechanical contact electrodes of the electrical rely from a closed to an open position and a following zero crossing of AC mains supply;
such that the time interval delays the sending of the output control signal from the microprocessor to the electrical relay so that switching of the electrical rely between ‘on’ and ‘off’ or ‘off’ and ‘on’ takes place at zero crossing of AC mains supply.

2. The electrical relay contact arrangement of claim 1 wherein the first lag time and the second lag time are measured prior to operational use of the electrical relay contact arrangement.

3. The electrical relay contact arrangement of claim 2 wherein the first lag time is measured by sending a first input signal to the electrical relay and measuring how long it takes for the mechanical contact electrodes of the electrical rely to be physically pulled closed from the open position to the closed position.

4. The electrical relay contact arrangement of claim 2 wherein the second lag time is measured by sending a second input signal to the electrical relay and measuring how long it takes for the mechanical contact electrodes of the electrical rely to be physically separated open from the closed position to the open position.

5. The electrical relay contact arrangement of claim 3 wherein the measured first lag time and second lag time are stored in non-volatile memory of the microprocessor or non-volatile memory to which the microprocessor has access.

6. The electrical relay contact arrangement of claim 5 wherein the non-volatile memory is electrically erasable programmable read-only memory (EEPROM).

7. The electrical relay contact arrangement of claim 6 wherein the electrically erasable programmable read-only memory (EEPROM) is integrated with the microprocessor on a single integrated circuit chip.

8. The electrical relay contact arrangement of claim 4 wherein the measured first lag time and second lag time are stored in non-volatile memory of the microprocessor or non-volatile memory to which the microprocessor has access.

9. The electrical relay contact arrangement of claim 1 wherein the microprocessor is programmed to recognise the frequency of the AC mains supply such that time intervals between consecutive zero crossing intervals can be calculated by the microprocessor.
